(19) United States
(12) Patent Application Publication
(10) Pub. No.: US 2026/0358988 A1
(43) Pub. Date: Nov. 12, 2026

(54) PRINT DRIVER SUPPORT APPLICATION FOR MULTIPLE PRINTING DEVICE CAPABILITY

(71) Applicant: Hewlett-Packard Development Company, L.P., Spring, TX (US)

(72) Inventors: Sangmin LEE, Seongnam Si (KR); Mikyung CHOI, Seongnam Si (KR); Sohye KIM, Seongnam Si (KR); Rajivkumar Vinodchandra MISTRY, Boise, ID (US); Anil Datta Kumar B, Bangalore (IN)

(21) Appl. No.: 19/125,063

(22) PCT Filed: Oct. 31, 2022
(86) PCT No.: PCT/US2022/048412

§ 371 Date: Apr. 28, 2025

(51) Int. Cl. G06F 3/12

(52) U.S. Cl. CPC G06F 3/1226; G06F 3/1204; G06F 3/1206; G06F 3/1225; G06F 3/1232; G06F 3/1286; G06F 3/1287

(57) ABSTRACT

A print driver associated with a print queue. In response to execution of the print driver, a support application for the print driver retrieves a printer attribute. The support application identifies whether the printer attribute corresponds to multiple printing device capability. In response to identifying that the printer attribute corresponds to the multiple printing device capability, the support application locates available printing devices and receives selection of a target printing device from the available printing devices. The support application retrieves and stores driver information for the target printing device for subsequent printing to the target printing device.

### BACKGROUND

Printing devices include standalone printers that just have printing functionality, as well as all-in-one (AIO) devices that have other functionality, such as scanning and/or faxing functionality, in addition to printing functionality. Printing devices can print using a variety of technologies, including inkjet-printing and laser-printing technologies, among others. Printing devices can also include print server devices, which are computing devices that are communicatively connected to printers and that receive print jobs from other computing devices to dispatch to their connected printers. A print server device may be a cloud print server to which computing devices communicate over private or public networks, including the Internet.

### BRIEF DESCRIPTION OF THE DRAWINGS

FIG. 1 is diagram of an example print driver having a support application with multiple printing device capability.

FIGS. 2A and 2B are flowcharts of example methods for printing using a print driver having a support application with multiple printing device capability.

FIGS. 3A, 3B, 3C, and 3D are diagrams of example user interfaces (UIs) that can be opened in conjunction with a print driver having a support application with multiple printing device capability.

FIG. 4 is a diagram of an example non-transitory computer-readable data storage medium.

FIG. 5 is a flowchart of an example method.

FIG. 6 is a diagram of an example computing device.

### DETAILED DESCRIPTION

A printing device is used to print data, which may be generated or provided by an application running on a computing device, such as a desktop, laptop or notebook computer, communicatively connected to the printing device. The operating system of the computing device can include a print driver for the printing device. The operating system is system software that manages computer hardware and software resources, and provides common services for computer programs, like applications, running on the computing device.

A driver is generally a computer program the operates or controls a particular type of device to which a computing device is communicatively connected. A print driver is thus the software that operates or controls a printing device. The print driver converts data to be printed to a format that the printing can understand. That is, the print driver renders the data to be printed, which may be genereated by or received from an application, and then transmits the rendered data to the printing device for printing. The print driver may also permit various print settings of the printing device to be adjusted.

A print driver may be associated with a print queue to which a printing device corresponds. When an application running on a computing device provides data to be printed to a print driver, the print driver renders the data, and transmits the rendered data to the printing device via the print queue. The print queue permits multiple print jobs of data to effectively be sent to the printing device. If the printing device is currently printing the rendered data of one print job, a subsequent print job can remain in the print queue until the printing device is ready.

Some types of print drivers provide for multiple printing device capability. For example, the Universal Print Driver (UPD) available from HP Inc., which is headquartered in Palo Alto, Calif., can support multiple printing devices that all correspond to the same (virtual) print queue. This feature of UPD allows mobile users, for instance, to print documents to nearby printing devices using the same print queue. The UPD can be installed on computing devices running versions of the MICROSOFT WINDOWS operating system, available from Microsoft Corp., which is headquartered in Redmond, Wash.

A UPD is thus associated with one print queue, which is a virtual print queue. When first used, the UPD locates available local and remote printing devices from which a user can select a target printing device. The UPD retrieves driver information for the target printing device, and subsequently can render data using the driver information and transmit the rendered data to the target printing device via the virtual print queue for printing. Therefore, the UPD is a single print driver that can support multiple printing devices.

Other types of print drivers, however, do not provide for multiple printing device capability. In the context of more recent versions of the WINDOWS operating system, an Internet Printing Protocol (IPP) print driver can support just a single printing device exclusively associated with a single print queue. The IPP print driver retrieves driver information for this particular printing device (which the driver may itself store), and subsequently can render data using the driver information and transmit the rendered data to the particular printing device via the exclusive print queue for printing.

As operating systems move to an IPP print driver framework, this means that a user of a computing device has to individually install a driver for each printing device that the user wishes to use for printing. By comparison, a UPD permits the user to install just one driver, associated with one virtual print queue, and which supports multiple printing devices, from which the user can select a nearby target printing device to use for printing via the UPD. The IPP print driver framework does not support UPD capability, however, which can be inconvenient to mobile users in particular.

Techniques described herein extend a print driver associated with a print queue to which a particular printing device exclusively corresponds to provide multiple printing device capability. For example, an IPP print driver can be extended to provide UPD capability in the context of versions of the WINDOWS operating system The techniques can provide a support application for such a print driver, such as a print support app (PSA) for an IPP print driver, for instance, where the support application itself has multiple printing device capability such as UPD support. A user has to install just one driver for multiple printing device capability, even in the context of an IPP print driver framework.

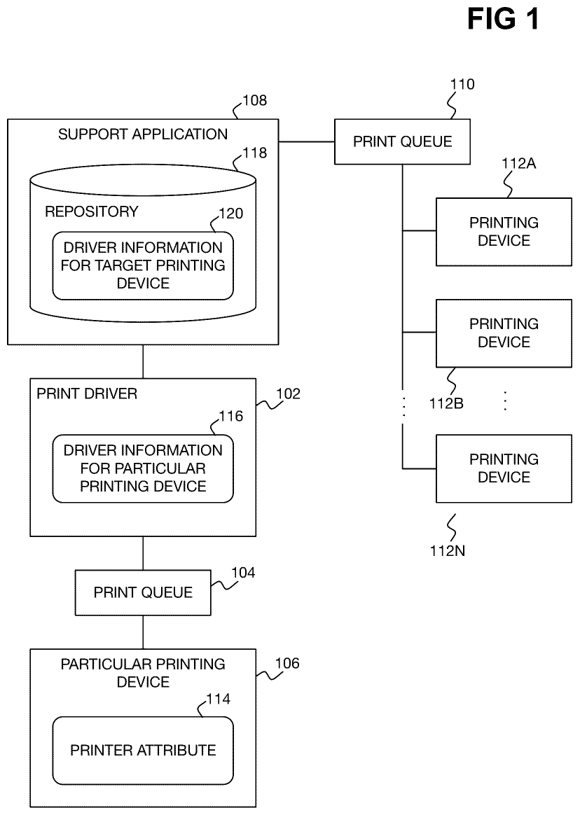

FIG. 1 shows an example print driver 102 that is associated with a print queue 104 to which a particular printing device 106 exclusively corresponds. The print driver 102 thus may be considered as being for the printing device 106. The printing device 106 exclusively corresponds to the print queue 104 in that the print queue 104 is only for the printing device 106 and not for any other printing device. The print driver 102 may be an IPP print driver that is installed on a computing device running a version of the WINDOWS operating system.

A support application 108 is linked with or otherwise connected to the print driver 102. The support application 108 may be a PSA in the case in which the print driver 102 is an IPP print driver. For instance, versions of the WINDOWS operating system may provide IPP print driver extensibility through a PSA application programming interface (API), permitting the PSA to read driver information, customize a user experience provided by user interfaces (UIs), and render print data.

The support application 108 thus can extend the print driver 108 to provide multiple printing device capability. In particular, the support application 108 is associated with printing devices 112A, 112B, . . . , 112N, which are collectively referred to as the printing devices 112. The printing devices 112 can include local and remote printing devices, including local and remote standalone printers and all-in-one (AIO) printing devices, as well as print servers such as cloud print servers.

A local printing device 112 can be directly connected, either in a wired or wireless manner, to the computing device on which the print driver 102 has been installed. A local printing device 112 may instead be accessible on the same network, such as the same local-area network (LAN), as the computing device. By comparison, a remote printing device 112 may be accessible over a different network, such as a wide-area network (WAN), an intranet, an extranet, and/or the Internet.

The particular printing device 106 may also be a local or remote printing device, including a cloud print server. The printing device 106 has a printer attribute 114 corresponding to multiple printing device capability. In the case in which the print driver 102 is an IPP print driver, the printer attribute 114 may be an IPP public attribute such as “printer-info” that can be set to “UPD for IPP.” As another example, the printer attribute 114 may be an IPP private attribute such as “vendor-printer-type” that can be set to “UPD.”

The print driver 102 associated with the print queue 104 may be selected just when the particular printing device 106 is connected to the computing device on which the operating system in conjunction with which the print driver 102 has been installed is running. This means that the multiple printing device capability provided by the support application 108 for the print driver 102 is available just when the particular printing device 106 is connected. If the printing device 106 is not connected, the print driver 102 will not be able to be selected, which means that the support application 108 cannot run.

Therefore, in one implementation, the printing device 106 should be a remote printing device, such as a cloud print server, available over a network. This ensures that the print driver 102 is able to be selected, so that the support application 108 can run and the multiple printing device capability provided by the support application 108 can be used. If the printing device 106 is instead a local printing device and is disconnected, the print driver 102 is not able to be selected, such that the support application 108 cannot run and its multiple printing device capability cannot be used.

The print driver 102 can store driver information 116 for the particular printing device 106. The print driver 102 may store the driver information 116 after having retrieve the driver information 112 from the printing device 106 itself. The driver information 116 includes information as to how data should be rendered for printing by the particular printing device 106. The driver information 116 can also include other information regarding the printing device 106, such as various print settings of the printing device 106 that can be adjusted. Such print settings can include color mode (e.g., black-and-white or full-color printing) and print quality (e.g., draft, regular, or highest print quality), among other settings.

The support application 108 includes a repository 118. When the user initially selects a target printing device 112 from the available printing devices 112, the support application 108 retrieves driver information 120 for the target printing device 112 and stores the driver information 120 in the repository 118. The driver information 120 includes information as to how data should be rendered for printing by the target printing device 112. The driver information 120 can also include other information regarding the target printing device 112, such as various printing settings that can be adjusted.

In operation, when the print driver 102 is executed, the support application 108 retrieves the printer attribute 114 from the particular printing device 106. If the printer attribute 114 does not correspond to multiple printing device capability, then printing can occur just on the particular printing device 106. In this case, the support application 108 retrieves the driver information 116 for the particular printing device 106, renders data to be printed using the driver information 116, and transmits the rendered data to the printing device 106 via the print queue 104.

However, if the printer attribute 114 does correspond to multiple printing device capability, then printing can occur on any available printing device 112. If a target printing device 112 was previously selected and is available, then the support application 108 retrieves the driver information 120 for the target printing device 112 from the repository 118. The support application 108 renders data to be printed using the driver information 120, and transmits the rendered data to the target printing device 112 via the virtual print queue 110. The print queue 104 is not used in this case.

If a target printing device 112 was not previously selected and/or is unavailable, or if a user wishes to select a new target printing device 112, then the support application 108 locates available printing devices 112 from which the target printing device 112 is selected. The support application 108 retrieves the driver information 120 from the target printing device 112 for storage in the repository 118. The support application 108 then renders data to be printed using this driver information 120, and transmits the rendered data to the target printing device 112 via the virtual print queue 110 as above.

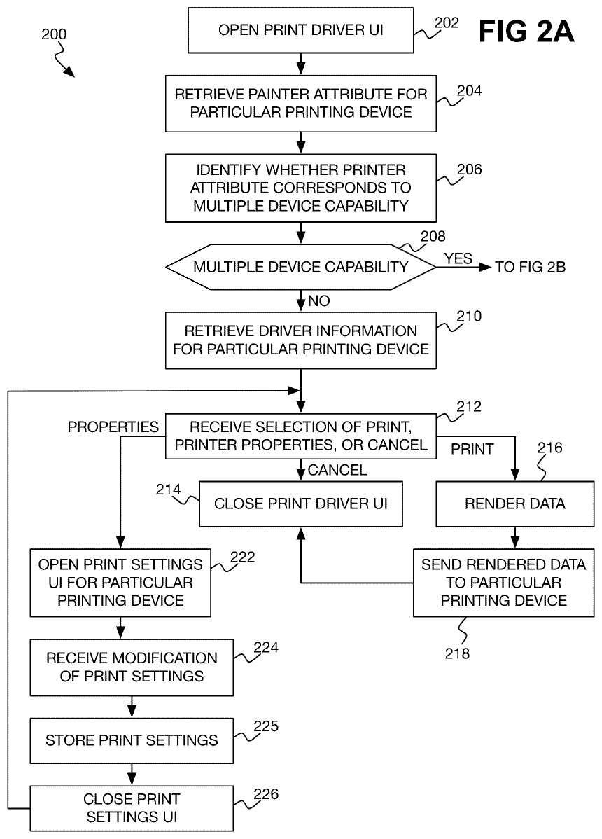

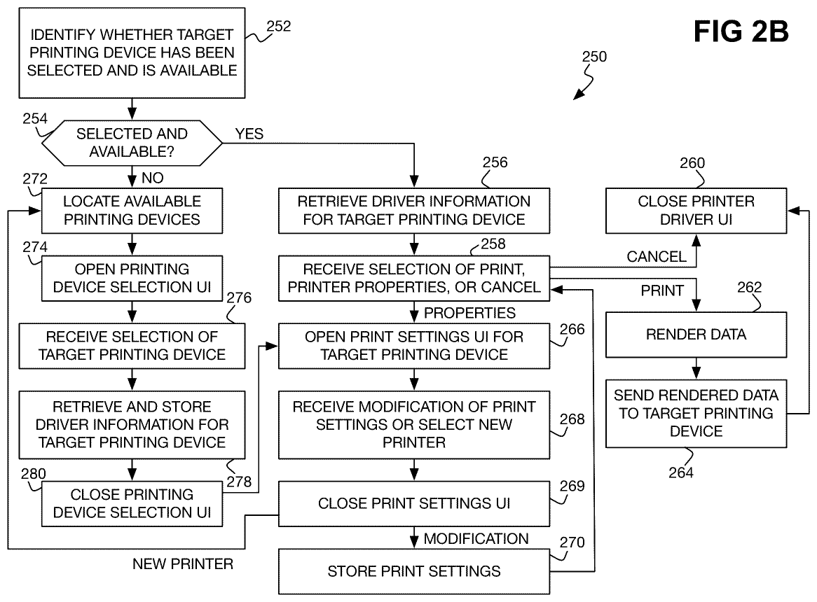

FIGS. 2A and 2B respectively show example methods 200 and 250 for printing using the print driver 102 (e.g., an IPP print driver) having a support application 108 (e.g., a PSA) with multiple printing device capability (e.g., UPD support). The methods 200 and 250 are performed by a processor of a computing device, such as a desktop, laptop, or notebook computer, running an operating system (e.g., a version of the WINDOWS operating system) in conjunction with which the print driver 102 has been installed.

Referring to FIG. 2A, a UI of the print driver 102 is opened in the method 200 (202). Opening of the print driver UI results in execution of the print driver 102, and thus execution of the support application 108 of the print driver 102. For example, the print driver UI may be opened (and thus the print driver 102 may be executed) in response to an application running on the computing device initiating printing of data. The application runs in the context of the operating system. Examples of applications include word processing programs, web browsing programs, email communication programs, and spreadsheet programs, among a myriad of different kinds of applications.

The support application 108, via the print driver 102, retrieves the printer attribute 114 from the particular printing device 106 (204). The support application identifies whether the printer attribute 114 corresponds to multiple printing device capability (206). If the printer attribute 114 corresponds to multiple device capability (208), then processing continues with the method 250 of FIG. 2B, with the method 200 of FIG. 2A being completed.

The remainder of the method 200 pertains to the printer attribute 114 not corresponding to multiple device capability (including when the attribute 114 is absent). In the described example, the remainder of the method 200 is performed by the support application 108. However, in another implementation, the remainder of the method 200 can instead be performed by the print driver 102 itself, instead of the support application.

The support application 108 retrieves the driver information 116 for the particular printing device 106 from the print driver 102 (210). (If the print driver 102 does not yet have the driver information 116, the print driver 102 first retrieves the driver information 116 from the printing device 106.) The print driver UI may include options to print data (as provided by the application), view printer properties, or cancel. The support application 108 thus receives user selection of print, printer properties, or cancel (212). If the user has selected cancel, then the print driver UI is closed (214), and the method 200 is finished. The support application 108 can cache the driver information 116 in one implementation, so that subsequent retrieval from the print driver 102 is unnecessary.

If the user has selected print, then the support application 108 renders data provided by the application in which opening of the print driver UI was initiated, using the driver information 116 (216). The support application 108 sends the rendered data to the particular printing device 106 via the print queue 104 to which the printing device 106 exclusively corresponds (218), which results in printing of the data by the particular printing device 106. The print driver UI is then closed (214), completing the method 200.

If the user has selected printer properties, then the support application 108 opens a print settings UI for the particular printing device 106, based on the driver information 116 for the particular printing device 106 (222). The print settings UI permits user modification of print settings in accordance with which data to be printed is rendered and thus printed by the particular printing device 106. The support application 108 can receive modification of the print settings (224), store the modified print settings within the driver information 116 (225), and close the print settings UI (226). The method 200 proceeds back to 212, where print, printer properties, or cancel can again be selected.

Referring to FIG. 2B, when the printer attribute 114 corresponds to multiple printing device capability, the support application 108 identifies whether a target printing device 112 has already been selected and is currently available (252). If a target printing device 112 has been selected and is available (254), then the support application 108 retrieves the driver information 120 for the target printing device 112 from the repository 118 to which the driver information 120 was previously saved (256).

As noted above, the print driver UI opened in 202 of FIG. 2A may include options to print data (as provided by the application), view printer properties, or cancel. The support application 108 thus receives user selection of print, printer properties, or cancel (258). If the user has selected cancel, then the print driver UI is closed (214). The method 250 is thus finished.

If the user has selected print, then the support application 108 renders data provided by the application in which opening of the UI was initiated, using the driver information 120 (262). The support application 108 sends the rendered data to the target printing device 112 via the virtual print queue 110 shared by all the available multiple printing devices 112 (264), which results in printing of the data by the target printing device 112. The print queue 104 is thus not used. The print driver UI is then closed (260), completing the method 250.

If the user has selected printer properties, then the support application 108 opens a print settings UI for the target printing device 112, based on the driver information 120 for the target printing device 112 (266). The print settings UI permits user modification of print settings in accordance with which data to be printed is rendered and thus printed by the target printing device 112. The print settings UI also permits user selection of a new (i.e., different) target printing device 112.

The support application 108 can therefore receive modification of the print settings or an indication that a new target printing device 112 is to be selected (268). In either case, the support application 108 closes the print settings UI (270). If the print settings have been modified (as opposed to the user having opted to select a new target printing device 112), then the support application 108 stores the modified print settings within the driver information 120 (270). The method 250 then proceeds back to 258, where print, printer properties, or cancel can be selected within the print driver UI.

If the user has opted to select a different target printing device 112, then the support application 108 locates available printing devices 112 (272). The method 250 also proceeds to 272 in the case in which a target printing device 112 was not previously selected, or a target printing device 112 was previously selected but is not currently available (254). Therefore, the first time the print driver UI is opened, the method 250 may initially proceed to 272 (in the case in which the printer attribute 114 corresponds to multiple printing device capability).

The support application 108 opens a printing device selection UI (274). The printing device selection UI lists available printing devices 112, from which a target printing device 112 can be selected by the user. If a target printing device 112 has previously been selected and is available (i.e., in the case in which the user has opted to select a different target printing device 112 in 258), the already selected target printing device 112 may be highlighted in the printing device selection UI.

The support application 108 thus receives user selection of a target printing device 112 from the available printing devices 112 listed in the printing device selection UI (276). The support application 108 retrieves the driver information 120 from the target printing device 112, and stores the driver information 120 within the repository 118 (278). If the driver information 120 for the selected target printing device 112 was previously retrieved and stored in the repository 118, the newly retrieved driver information 120 may overwrite the previously stored driver information 120 in the repository 118.

The support application 108 closes the printing device selection UI (280). (The printing device selection UI may be closed before or after the driver information 120 for the target printing device 112 has been retrieved and stored in the repository 118). The method 250 then proceeds back to 266, where the print settings UI for the target printing device 112 is opened.

The methods 200 and 250 illustrate an example manner by which the support application 108 can print to the particular printing device 106 in the case in which the printer attribute 114 does not correspond to multiple printing device capability, and to one of a number of available printing devices 112 in the case in which the attribute 114 does correspond to multiple printing device capability. The support application 108 extends a print driver 102 associated with a print queue 104 to which one particular printing device 106 exclusively corresponds to also have multiple printing device capability.

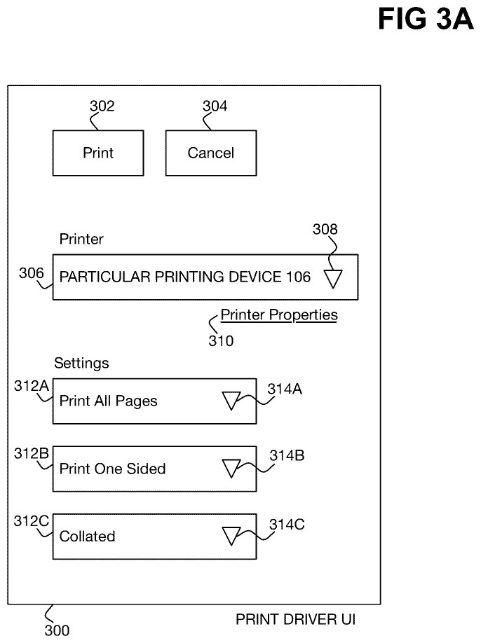

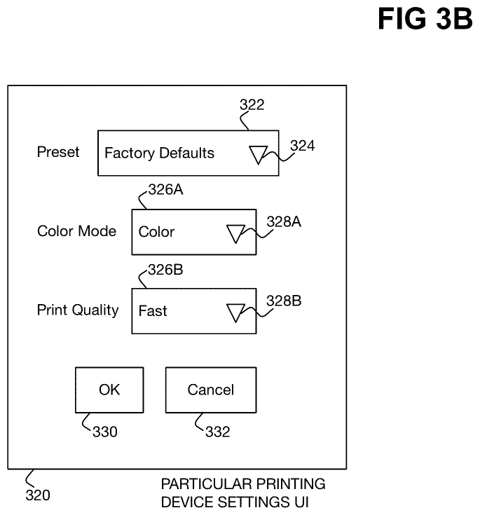

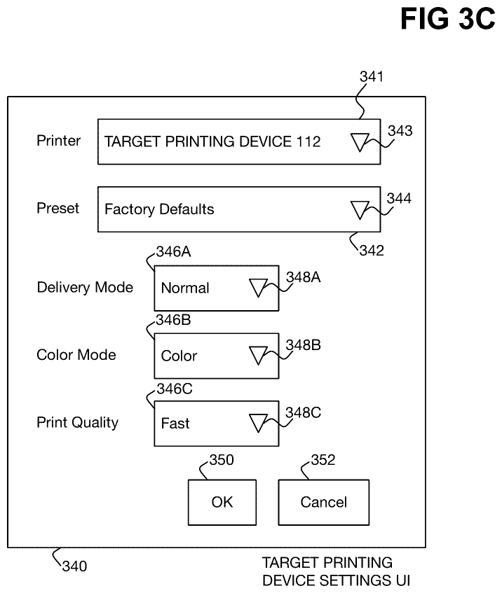

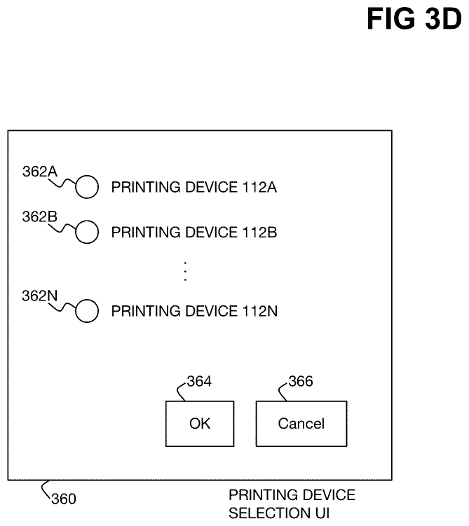

FIG. 3A shows an example print driver UI 300 that may be opened in 202 of the method 200 of FIG. 2A. The print driver UI 300 includes print and cancel buttons 302 and 304. Selection of the print button 302 corresponds to selection of print in 212 of the method 200 and to selection of print in 258 of the method 250 of FIG. 2B, depending on whether the printer attribute 114 corresponds to multiple printing device support. Selection of the cancel button 304 button similarly corresponds to selection of cancel in 212 and 258 of the methods 200 and 250, respectively.

The print driver UI 300 can include a dropdown box 306 identifying the particular printing device 112 exclusively corresponding to the print queue 104. A user can select the triangle 308 of the box 306 to choose a different particular printing device 106 exclusively corresponding to a different print queue 104. That is, the dropdown box 306 is not used to select from available printing devices 112 corresponding to the same virtual print queue 110, but rather to select from among available particular printing devices 106 that exclusively correspond to respective print queues 104.

The printer driver UI 300 may include a printer properties link 310, such as a hyperlink. Selection of the link 310 corresponds to printer properties selection in 212 of the method 200 of FIG. 2A in the case in which the printer attribute 114 does not correspond to multiple printing device support. Selection of the link 310 corresponds to printer properties selection in 258 of the method 250 of FIG. 2B in the case in which the printer attribute 114 does correspond to multiple printing device support.

The print driver UI 300 may include dropdown boxes 312A, 312B, and 312C, collectively referred to as the dropdown boxes 312, and which respectively have triangles 314A, 314B, and 314C. Three dropdown boxes 312 are depicted, but there may be less than three (including none) or more than three boxes 312. The dropdown boxes 312 correspond to different print settings that may be modified within the print driver UI 300 itself. These print settings can be universal print settings that may be applicable regardless of the printing device 106 or 112 to which rendered data is transmitted for printing.

The dropdown box 312A corresponds to the number of pages that are to be printed. As depicted, currently all the pages are to be printed. Selection of the triangle 314A may permit a user to instead select a single page, a range of pages, or multiple ranges of pages. The dropdown box 312B corresponds to whether printing should occur on one side of a sheet (i.e., simplex printing) or on both sides of a sheet (i.e., duplex printing). As depicted, currently single-sided (i.e., one-sided) printing is selected. Selection of the triangle 314B may permit a user to instead select double-sided printing.

The dropdown box 312C corresponds to whether printed sheets should be collated, in the case in which multiple copies of the pages are printed. As depicted, currently collated printing is selected, such that all the pages are printed for the first copy, then all the pages are printed for the second copy, and so on. Selection of the triangle 314C may permit a user to instead select uncollated printing, such that all copies of the first page are printed, then all copies of the second page are printed, and so on.

FIG. 3B shows an example print settings UI 320 for the particular printing device 106 that may be opened in 222 of the method 200 of FIG. 2A. The print settings UI 320 can include a dropdown box 322 among which different presets of the print settings for the particular printing device 106 may be selected or saved via selection of the triangle 324. As depicted, currently the factory default print settings are selected.

The print settings UI 320 can include dropdown boxes 326A and 326B, collectively referred to as the dropdown boxes 326, and which respectively have triangles 328A and 328B. Two dropdown boxes 326 are depicted, but there may be less or more than two boxes 326. The dropdown boxes 326 correspond to different print settings that may be modified within the print settings UI 320. These print settings may be print settings specified by the driver information 116 for the particular printing device 106, and thus which may be specific to the particular printing device 106.

The dropdown box 326A corresponds to a color mode setting. As depicted, currently (full-)color printing is selected. Selection of the triangle 328A can permit a user to instead select monochromatic (i.e., black-and-white) instead. The dropdown box 326A corresponds to a print quality setting. As depicted, currently fast is selected, corresponding to fastest but lowest quality printing. Selection of the triangle 328B may permit a user to instead select regular, corresponding to slower but higher quality printing, or highest, corresponding to slowest but highest quality printing.

The print settings UI 320 can include OK and cancel buttons 330 and 332. Selection of the OK button 330 results in storage of the modified print settings within the driver information 116 in 225 of the method 200 of FIG. 2A, followed by closing of the print settings UI 320 in 226 of the method 200. Selection of the cancel button 332 results in closing of the print settings UI 320 in 226 of the method 200 without storing the modified print settings in 225 of the method 200.

FIG. 3C shows an example print settings UI 340 for the target printing device 112 that may be opened in 206 of the method 250 of FIG. 2B. The print settings UI 340 includes a dropdown box 341 identifying the target printing device 112. Selection of the triangle 343 can permit a user to select a different target printing device 112. The print settings UI 342 can include a dropdown box 342 among which different presets of the print settings for the target printing device 106 may be selected or saved via selection of the triangle 344.

The print settings UI 340 can include dropdown boxes 346A, 346B, and 346C, collectively referred to as the dropdown boxes 346, and which respectively have triangles 348A, 348B, and 348C. Three dropdown boxes 346 are depicted, but there may be less or more than three boxes 346. The dropdown boxes 346 correspond to different print settings that may be modified within the print settings UI 340. These print settings may be print settings specified by the driver information 120 for the target printing device 112, and thus which may be specific to the target printing device 112.

The dropdown box 346A corresponds to a delivery mode setting. As depicted, the target printing device 112 delivers print jobs normally, such that print jobs are not stapled and are not collated (i.e., stacked) into different output bins. Selection of the triangle 348A may permit a user to instead specify that print jobs are to be stapled and/or collated into different output bins. The dropdown boxes 346B and 346C respectively correspond to color mode and print quality settings, as has been described in relation to the print settings UI 320 for the particular printing device 106 of FIG. 3B.

The print settings UI 340 can include OK and cancel buttons 350 and 352. Selection of the OK button 350 results in closing of the print settings UI 340 in 269 of the method 200 of FIG. 2B, and storage of the modified print settings within the driver information 120 in 270 of the method 250. Selection of the cancel button 352 results in closing of the print settings UI 340 in 269 of the method 200 without storing the modified print settings in 270 of the method 250.

FIG. 3D shows an example target printing device selection UI 360 that may be opened in 274 of the method 250 of FIG. 2B. The printing device selection UI 360 is opened if a target printing device 112 has not been previously selected, or if the target printing device 112 has been selected but is not currently available. In the case in which the target printing device 112 has been selected and is available, the printing device selection UI 360 is opened if the user has opted to select a new target printing device 112.

The target printing device selection UI 360 can list all available printing devices 112A, 112B, . . . , 112N, alongside corresponding radio buttons 362A, 362B,. 362N, respectively, which are collectively referred to as the radio buttons 362. The user selects the radio button 362 corresponding to the printing device 112 that the user has chosen to be the target printing device 112, resulting in automatic deselection of the radio button 362 corresponding to the previously selected target printing device 112 (if any).

The target printing device selection UI 360 includes OK and cancel buttons 364 and 366. The OK button 364 is selectable once a radio button 362 has been selected, to confirm selection of the corresponding printing device 112 as the target printing device 112. The cancel button 366 is selectable just if a target printing device 112 was previously selected and is currently available, to cancel selection of a different printing device 112 as the target printing device 112.

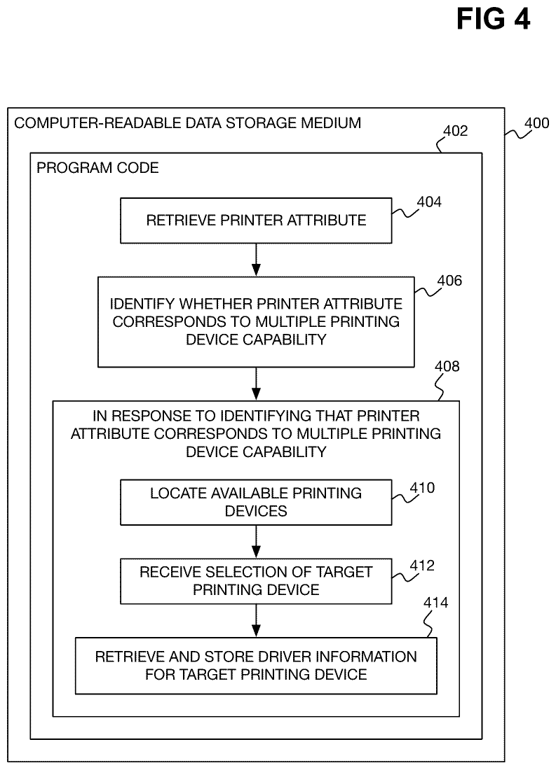

FIG. 4 shows an example non-transitory computer readable data storage medium 400 storing program code 402. The program code 402 is executable by a computing device, such as a desktop, laptop, or notebook computer, to implement a support application 108 for a print driver 102 associated with a print queue 104, so that the support application 108 performs processing. The processing includes, in response to execution of the print driver 102, retrieving a printer attribute 114 for a particular printing device 106 exclusively corresponding to the print queue 104 (404).

The processing includes identifying whether the printer attribute 114 corresponds to multiple printing device capability (406). The processing includes, in response to identifying that the printer attribute 114 corresponds to the multiple printing device capability (408), performing the following. Available printing devices 112 are located (410). Selection of a target printing device 112 from the available printing devices 112 is received (412). Driver information 120 for the target printing device 112 is received and stored for subsequent printing to the target printing device (414).

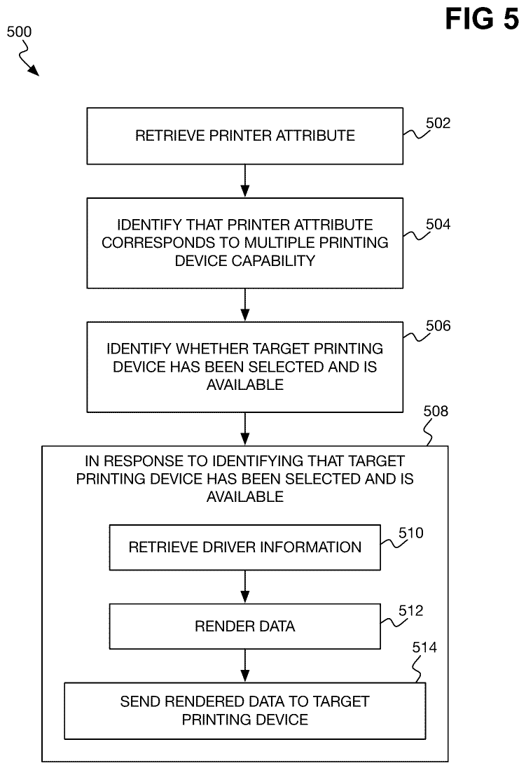

FIG. 5 shows an example method 500. The method 500 includes, in response to an application running on a computing device initiating printing of data, retrieving, by a support application 108 for a print driver 102 running on the computing device and associated with a print queue 104, a printer attribute 114 for a particular printing device 106 exclusively corresponding to the print queue 104 (502). The method 500 includes in response to identifying that the printer attribute 114 corresponds to multiple printing device capability (504), identifying, by the support application 108, whether a target printing device 112 has been selected and is available (506).

The method 500 includes, in response to identifying that the target printing device 112 has been selected and is available (508), performing the following. The support application 108 retrieves driver information 120 for the target printing device 112 previously stored by the support application 108 (510). The support application 108 renders the data using the driver information 120 for the target printing device 112 (512). The support applications sends the data, as rendered, to the target printing device 112 for printing, without using the print queue 104 with which the print driver 102 that the support application 108 is for is associated (514).

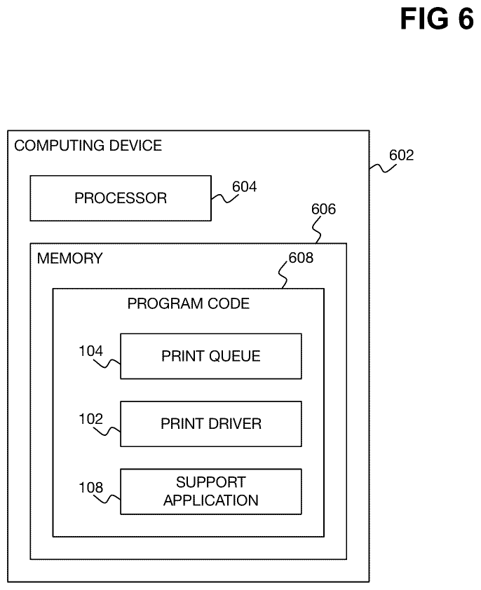

FIG. 6 shows an example computing device 602. The computing device 602 may be a desktop, laptop, or notebook computer, or another type of computing device. The computing device 602 includes a processor 604 and a memory 606 storing program code 608. The program code 608 is executable by the processor 604 to implement a print queue 104, a print driver 102 associated with the print queue 104, and a support application 108 for the print driver 102.

The print queue 104 is that to which a particular printing device 106 exclusively corresponds, where the particular printing device has a printer attribute 114 corresponding to multiple printing device capability. The support application 108, in response to identifying that the printer attribute 114 corresponds to the multiple printing device capability, locates available printing devices 112 and retrieves and stores driver information 120 for a target printing device 112 selected from the available printing devices 112.

Techniques have been described for an extending a print driver associated with a print queue to which a single printing device exclusively corresponds to support multiple printing device capability, via a support application for the print driver. For instance, a PSA with UPD support can extend an IPP print driver, so that multiple printing devices associated with the same virtual print queue can also be used via the IPP print driver. The single printing device corresponding to the print queue with which the print driver is associated has a printer attribute corresponding to multiple printing device capability in this respect.

We claim:

1. A non-transitory computer readable data storage medium storing program code executable by a computing device to implement a support application for a print driver associated with a print queue, the support application performing processing comprising:
in response to execution of the print driver, retrieving a printer attribute;
identifying whether the printer attribute corresponds to multiple printing device capability; and
in response to identifying that the printer attribute corresponds to the multiple printing device capability:
locating available printing devices;
receiving selection of a target printing device from the available printing devices; and
retrieving and storing driver information for the target printing device for subsequent printing to the target printing device.

2. The non-transitory computer-readable data storage medium of claim 1, wherein a cloud print server exclusively corresponds to the print queue, and the available printing devices are local or remote printing devices that do not include the cloud print server.

3. The non-transitory computer-readable data storage medium of claim 1, wherein the support application is a print support app (PSA), the print driver is an Internet Printing Protocol (IPP) print driver, and the multiple printing device capability is a Universal Print Driver (UPD) capability.

4. The non-transitory computer-readable data storage medium of claim 1, wherein a particular printing device exclusively corresponds to the print queue in that the print queue is only for the particular printing device and not any other printing device.

5. The non-transitory computer-readable data storage medium of claim 1, wherein the available printing devices correspond to a same multiple printing device print queue different than the print queue to which a particular printing device exclusively corresponds.

6. The non-transitory computer-readable data storage medium of claim 1, wherein the print driver is executed in response to opening of a user interface (UI) of the print driver.

7. The non-transitory computer-readable data storage medium of claim 1, wherein the print driver is executed in response to initiating printing of data by an application running on the computing device.

8. The non-transitory computer-readable data storage medium of claim 7, wherein the processing further comprises, in response to identifying that the printer attribute corresponds to the multiple printing device capability:
rendering the data using the driver information for the target printing device; and
sending the data, as rendered, to the target printing device for printing, without using the print queue with which the print driver that the support application is for is associated.

9. The non-transitory computer-readable data storage medium of claim 7, wherein, in response to identifying that the printer attribute does not correspond to the multiple printing device capability, data is rendered using driver information for a particular printing device exclusively corresponding to the print queue, and the data as rendered is sent to the particular printing device using the print queue with which the print driver is associated.

10. A method comprising:
in response to an application running on a computing device initiating printing of data, retrieving, by a support application for a print driver running on the computing device and associated with a print queue, a printer attribute;
in response to identifying that the printer attribute corresponds to multiple printing device capability, identifying, by the support application, whether a target printing device has been selected and is available;
in response to identifying that the target printing device has been selected and is available:
retrieving, by the support application, driver information for the target printing device previously stored by the support application;
rendering, by the support application, the data using the driver information for the target printing device; and
sending the data, as rendered, from the support application to the target printing device for printing, without using the print queue with which the print driver that the support application is for is associated.

11. The method of claim 10, further comprising, in response to identifying that the target printing device has been selected and is available:
opening, by the support application, a target printing device settings user interface (UI) for the target printing device based on the driver information for the target printing device; and
receiving modification of print settings of the target printing device via the target printing device settings UI.

12. The method of claim 10, further comprising, in response to identifying that the printer attribute corresponds to multiple printing device capability, and in response to identifying that the target printing device either has not been selected or has been selected but is not available:
locating, by the support application, available printing devices;
opening, by the support application, a printing device selection UI listing the available printing devices;
receiving, by the support application, selection of the target printing device from the available printing devices; and
retrieving and storing, by the support application, the driver information for the target printing device.

13. The method of claim 10, further comprising, in response to identifying that the printer attribute does not correspond to the multiple printing device capability: rendering, by the support application, the data using the driver information for a particular printing device exclusively corresponding to the print queue; and
sending the data, as rendered, to the particular printing device using the print queue.

14. A computing device comprising:
a processor; and
a memory storing program code executable by a processor to implement:
a print queue;
a print driver associated with the print queue; and
a support application for the print driver to, in response to identifying that a printer attribute corresponds to the multiple printing device capability, locates available printing devices and retrieves and stores driver information for a target printing device selected from the available printing devices.

15. The computing device of claim 14, wherein the program code is executable by the processor to further implement an application program,
wherein print driver is executed in response to the application initiating printing of data,
and wherein the support application is further to:
render the data using the driver information for the target printing device; and
send the data, as rendered, to the target printing device for printing, without using the print queue to which the print driver that the support application is for is associated.
